(19) United States
(12) Patent Application Publication
(10) Pub. No.: US 2004/0004527 A1
(43) Pub. Date: Jan. 8, 2004

(54) Wideband microwave power inductor with heatsink

(76) Inventors: David Geller, Scotts Valley, CA (US); Vince Chio, Mountain View, CA (US)

Correspondence Address: FLIESLER DUBB MEYER & LOVEJOY, LLP, FOUR EMBARCADERO CENTER, SUITE 400, SAN FRANCISCO, CA, 94111, US

(21) Appl. No.: 10/191,037

(22) Filed: Jul. 3, 2002

(51) Int. Cl. H01F 27/28

(52) U.S. Cl. 336/225

(57) ABSTRACT

An inductor coil is made with winding turns in a conical shape, tapered from a very small diameter and gradually increasing. The core of the coil is composed of a dielectric material with a colloidal suspension of magnetic particles, i.e. poly-iron. A heatsink, such as a wire or ceramic rod, is partially embedded in the core. The heatsink functions to remove heat from the core, thereby reducing the temperature rise during inductor operation. The reduction in temperature rise permits operation at currents above 1.0 amp while preserving high-frequency performance.

### CROSS-REFERENCE TO RELATED APPLICATIONS

The following applications are cross-referenced and incorporated herein by reference:

U.S. patent application Ser. No. 10/080,343 entitled “Microwave Inductor With Poly-iron Core Configured To Limit Interference With Transmission Line Signals”, filed Feb. 21, 2002.

U.S. patent application Ser. No. 09/027,087 entitled “Lumped Element Microwave Inductor With Windings Around Tapered Poly-iron Core”, filed Feb. 2, 1998.

### FIELD OF THE INVENTION

The present invention relates to temperature control for microwave inductors, such as may be used over a wide bandwidth from low to high frequency microwave applications.

### BACKGROUND

U.S. patent application Ser. No. 09/027,087 (the '087 application) entitled a “Lumped Element Microwave Inductor With Windings Around A Tapered Poly-Iron Core” includes an embodiment of an inductor that is made from wire wound in a conical shape. This wire has an interior core portion filled with a material such as poly-iron. FIG. 1 shows such a conical shaped inductor 100 connected by a wire portion 102 to a coaxial center conductor 104.

As shown by FIG. 2, a cutaway of the inductor of FIG. 1, the core material 200 of the inductor 100, can fill the windings 202 of the coils of the inductor 100. A suggested core material is poly-iron, which is a mixture of iron powder and epoxy binding material. Other suitable core materials are described in the '087 application. For convenience, the inductor 100 is carried over from FIG. 1 to FIG. 2, and is similarly labeled, as will be components carried over in subsequent drawings.

The conical shaped inductor with a poly-iron core can be used as an element in a filter, or as a bias coil or choke for injecting current into a transmission line of a circuit without disturbing the impedance of a transmission line. For high frequency microwave applications, it is desirable that an inductor does not experience significant resonant losses and can operate over a wide bandwidth while providing a high Q, or high quality factor.

A conical inductor with a poly-iron core can be used by connecting a small end of the winding 102 to a microstrip or coaxial transmission line, such as coaxial center core 104. Insertion loss performance can be improved by attaching the inductor tip, or small end 102, as close as practical to a transmission line or center conductor. If the inductor is positioned very close to a transmission line, the poly-iron core can interfere with the electromagnetic fields in the inductor and the electromagnetic fields in the transmission line Interference with the electromagnetic fields can contribute to an increase in insertion loss in the transmission line.

A conical inductor with a poly-iron core has been successfully utilized for bias currents up to approximately 0.5 amperes. Above these currents, the ohmic heating from the resistance of the wire can cause the temperature of the coil to rise significantly. Such rise in temperature can cause the poly-iron material, as well as the epoxy holding the coil together and in place, to degrade and eventually fail. A larger gauge wire can be used to form the coil, which can reduce the resistance and thus the temperature rise. This reduction in temperature rise comes at a price, however, as there is a corresponding degradation in high frequency performance.

### BRIEF SUMMARY

In accordance with the present invention, a system and method for reducing temperature rise in an inductor, while maintaining wideband microwave performance, is presented. A conical shaped inductor is comprised of a tapered coil of wire having winding turns. A conical shaped core is contained in a portion of the tapered coil of wire. The core is made up of a mixture of dielectric material and magnetic particles, forming a colloidal suspension of the magnetic particles. An elongated thermally conductive material, such as a wire or ceramic rod, is used as a heatsink for the inductor. A portion of the heatsink is positioned in the conical shaped core so that the heatsink can transfer heat from the core. A second end of the heatsink is connected to a metal structure, such as housing for circuitry, for dissipating heat. Use of the heatsink permits operation at currents above 1.0 ampere while preserving high-frequency performance.

Other features, aspects, and objects of the invention can be obtained from a review of the specification, the figures, and the claims.

### BRIEF DESCRIPTION OF THE DRAWINGS

FIG. 1 shows a conical shaped inductor connected to a coaxial cable of the prior art.

FIG. 2 shows a cutaway drawing of the inductor of FIG. 1 showing how the core material fills the windings.

FIG. 3 shows a heatsink embedded into a conical shaped inductor in accordance with one embodiment of the present invention.

FIG. 4 shows a cross-section of the heatsink and inductor of FIG. 3.

FIG. 5 shows measurements illustrating the reduction in temperature rise of the inductor of FIG. 3.

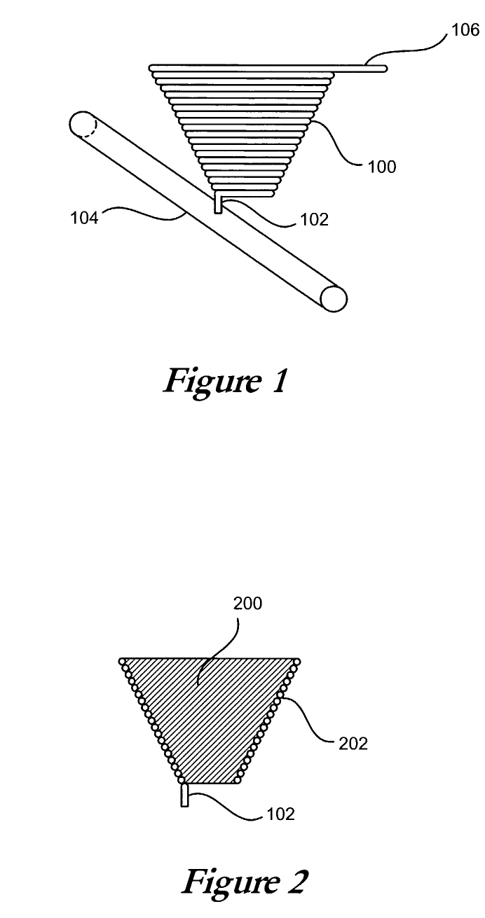

### DETAILED DESCRIPTION

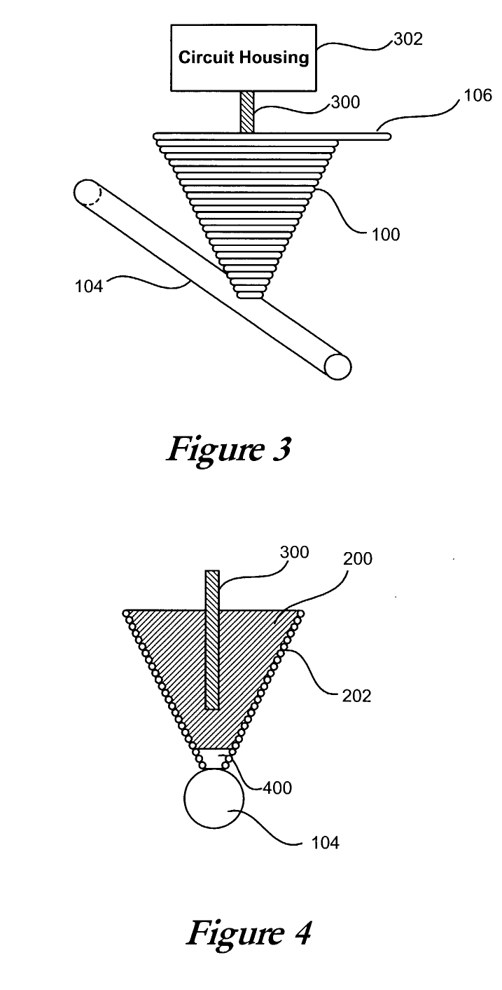

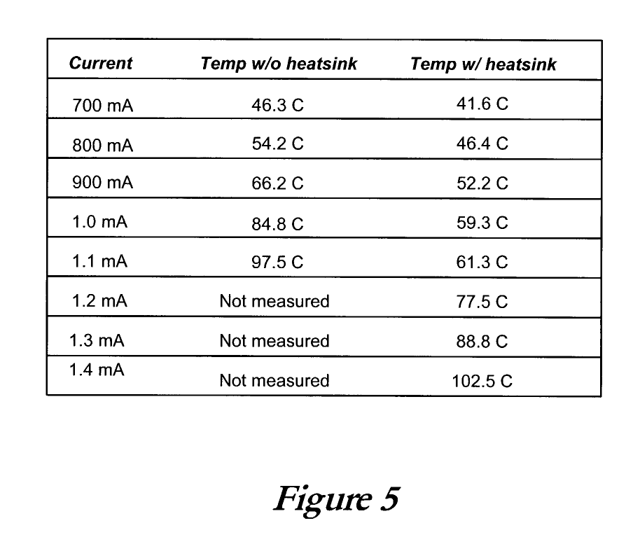

A system and method in accordance with of the present invention utilizes a heatsinking approach to temperature control. Heatsinking can be used to reduce the temperature rise of smaller gauge coils, thereby preserving the high-frequency performance while permitting operation at currents at, above, and well in excess of 1.0 ampere. A thermally conductive material, such as a wire, ceramic rod, or other elongated insertion, for example, can be embedded into the center of the poly-iron core. This embedding can be done when the inductor is formed, or can be inserted after the formation of the inductor. The elongated insertion, or heatsink, can also be embedded in other locations or orientations in the inductor. The position, length, thickness, and material of the heatsink can be varied to control the temperature rise and accommodate needs as may be related to space and cost. An embedded heatsink 300 is shown in FIG. 3. The heatsink wire 300 can be attached on a second end to a circuit housing 302, for example, by soldering or clamping. The attached wire can provide a low thermal impedance path for the inductor 100, to carry heat away from a transmission line or coaxial center conductor 104. The reduction in temperature of a typical inductor using such a method is shown in FIG. 5.

FIG. 4 illustrates a cutaway view of a microwave inductor that can be used in accordance with one embodiment of the present invention, as may be connected to a coaxial cable or transmission line. The inductor is composed of a coil of wire having winding turns 202 with diameters tapered from a first diameter φ₁ at one end of the coil to a second diameter φ₂ at a second end of the coil. The inductor further includes a core, with a portion 200 of the core comprised of a colloidal suspension of magnetic particles, the core material in one embodiment being poly-iron, and a portion 400 that is free of magnetic particles. Although shown with a portion 400 free of magnetic particles, in another embodiment, the core fills all of the windings. The portion 200 of the core occupied by the magnetic material is farthest from the narrowest diameter windings, the typical connection point for the coil to a transmission line. Removing some poly-iron at the narrow tip, leaving a portion without magnetic material, can eliminate the interference of electromagnetic field of a signal on the transmission line or coaxial center conductor 104 by magnetic material in the inductor.

The dielectric material used in the core portion 200 can be a polymeric material such as an epoxy resin, or a crystalline material such as glass. A dielectric material, such as epoxy, can coat each of the magnetic particles so that the particles are not in direct contact with each other, but are capacitively coupled. The percentage of magnetic particles relative to the dielectric material making up the core material 200 for the coil can be varied to control the inductance value of the coil.

To manufacture the inductor 200, wire can be wound in a toroidal fashion around a tapered object, such as a tapered mandrel. An adhesive can be applied to the wire to bind the windings together. Once the windings are sufficiently bound, the wire can be removed from the mandrel. The wire can also have an adhesive material coating its outer surface prior to being wound on the coil. The wire can then be immersed in a solvent, which can activate the adhesive and cause the windings to be bound together before the coil is removed from the mandrel.

To manufacture the core, with epoxy used as the dielectric material for the core, the epoxy can be mixed with the appropriate percentage of magnetic material and then poured into the center of the windings for the coil. To prevent the magnetic material from flowing into the small tip of the core, a small glass bead can be placed in the core prior to pouring in the epoxy mixed with iron powder. The viscosity of the epoxy can be controlled to prevent the epoxy and powdered iron mixture from passing the glass bead. Alternatively, epoxy without iron powder can be poured into the small tip and cured prior to pouring in epoxy with the iron powder mixed in, thereby preventing the magnetic material from flowing into the small tip of the core.

Before the epoxy begins to cure, or before the magnetic material hardens, a thermally conductive material can be inserted into the magnetic material. This thermally conductive material, or heatsink, can have a shape that can effect heat transfer away from the small tip of the core, such as that of a wire, rod, cylinder, or elongated rectangle, for example. The heatsink can be embedded in the magnetic material such that it is centered with respect to the windings of the wire, such as may run along a “center axis” of the cone. The heatsink can also be embedded at an angle with respect to the center axis of the cone, and can be located away from the center axis. The heatsink can extend into the cone toward the small tip any distance (1) from a point away from the tip that is just sufficient to hold the heatsink in place to (2) a point near the tip that is of a sufficient diameter to accept the heatsink in the magnetic material.

This embedding can also be effected after the epoxy has cured or the inductor is formed. This can be accomplished in one example by drilling or otherwise creating an opening in the magnetic material that is shaped to accept the heatsink. In another example, such an opening can be created by a molding process as the magnetic material is being inserted into the cone.

The temperature or material content of the epoxy can be controlled so that the viscosity of the epoxy enables the epoxy to cure within the center of the windings of the coil without running out between the windings. The viscosity can also be controlled to hold the heatsink in place after insertion. The core material 200 can be cured at atmospheric pressure, and temperature can be elevated above room temperature in order to accelerate the curing time. The core in at least one embodiment does not extend past the windings at the larger end of the inductor. The heatsink will extend beyond the core in most embodiments in order to allow connection to a circuit housing or other device, apparatus, or material capable of transferring heat from the inductor. The length which the heatsink extends can depend on the method of connection, whether by clamping, soldering, or other connection methods or means.

The inductor coil wire 202 can be specially prepared, insulated wire with the insulation removed at the ends. The lead 102 at the small end of the coil can be free of insulation for an appropriate length, such as within a distance from the first winding of the coil of no greater than twice the inner diameter of the small end of the coil, so that the lead length is minimal for the highest frequency operation. The uninsulated ends or leads 102 and 106 of the wire can be plated with tin, solder, or gold. The leads can be attached by reflow soldering or by the use of conductive epoxy.

The foregoing description of the preferred embodiments of the present invention has been provided for the purposes of illustration and description. It is not intended to be exhaustive or to limit the invention to the precise forms disclosed. Many modifications and variations will be apparent to the practitioner skilled in the art. Embodiments were chosen and described in order to best describe the principles of the invention and its practical application, thereby enabling others skilled in the art to understand the invention, the various embodiments and with various modifications that are suited to the particular use contemplated. It is intended that the scope of the invention be defined by the following claims and their equivalents.

What is claimed is:

1. An inductor comprising:
a coil of wire having winding turns with diameters tapered from a first small diameter end to a second large diameter end;
a conical shaped core provided in the coil of wire, the core having dielectric material supporting magnetic particles forming a colloidal suspension of the magnetic particles, and
an elongated thermally conductive material, a portion of the conductive material provided in the conical shaped core such that the conductive material can transfer heat from the core.

2. The inductor of claim 1,
wherein the elongated thermally conductive material is a wire.

3. The inductor of claim 1,
wherein the elongated thermally conductive material is a ceramic rod.

4. The inductor of claim 1,
wherein the elongated thermally conductive material is positioned along a central axis of the conical shaped core.

5. The inductor of claim 1,
wherein the elongated thermally conductive material further has an extension portion that extends beyond the second large diameter end.

6. The inductor of claim 5,
wherein the extension portion is attached to a circuit housing.

7. The inductor of claim 1,
wherein the core does not extend substantially past the second large diameter end.

8. The inductor of claim 1,
wherein the core is not provided within the winding turns for a number of turns from the first small diameter end.

9. The inductor of claim 1,
wherein the colloidal suspension of magnetic particles comprises poly-iron.

10. An inductor comprising:
a wire having first and second ends, the wire wound into a hollow conic coil having a small end and a large end, the small and large ends of the coil having inner and outer diameters and extending as first and second leads respectively;
a coating of electrical insulation on the wire, except on the leads;
a core comprising powdered iron bound with an adhesive binder partially filling the windings of the coil; and
a thermally conductive rod, a portion of the rod provided in the core such that the rod can transfer heat from the core.

11. A method of making an inductor, comprising:
winding a wire in a toroidal fashion around a tapered object to form a tapered coil;
removing the tapered coil from the tapered object;
pouring a mixture of epoxy and magnetic material into the tapered coil to form a core; and
embedding a portion of an elongated thermally conductive material in the core before the mixture cures.

12. A method of making an inductor, comprising:
winding a wire in a toroidal fashion around a tapered object to form a tapered coil;
removing the tapered coil from the tapered object;
pouring a mixture of epoxy and magnetic material into the tapered coil to form a core;
drilling a hole in the core after the epoxy cures, and
inserting a portion of an elongated thermally conductive material in the hole.

13. A method of making an inductor, comprising:
winding a wire in a toroidal fashion around a tapered object to form a tapered coil;
removing the tapered coil from the tapered object;
pouring a mixture of epoxy and magnetic material into the tapered coil to form a core;
molding an opening in the core as the epoxy cures, and
inserting a portion of an elongated thermally conductive material in the opening after the epoxy cures.

14. A method according to claim 11, further comprising:
centering the portion in the core with respect to the winds of the tapered coil.

15. A method according to claim 11, further comprising:
controlling the temperature of the mixture so that the viscosity of the mixture holds the portion in place as the mixture cures.

16. An inductor comprising:
a coil of wire having winding turns with diameters tapered from a first small diameter end to a second large diameter end;
a conical shaped core provided in the coil of wire, the core having dielectric material supporting magnetic particles forming a colloidal suspension of the magnetic particles, and
means for removing heat provided in the conical shaped core.
